(19) United States
(12) Patent Application Publication
(10) Pub. No.: US 2019/0067765 A1
(43) Pub. Date: Feb. 28, 2019

(54) LITHIUM AIR BATTERY THAT INCLUDES NONAQUEOUS LITHIUM ION CONDUCTOR

(71) Applicant: Panasonic Intellectual Property Management Co., Ltd., Osaka (JP)

(72) Inventors: MASAKO MORIISHI, Osaka (JP); YU OTSUKA, Osaka (JP)

(21) Appl. No.: 16/047,001

(22) Filed: Jul. 27, 2018

(30) Foreign Application Priority Data
Aug. 31, 2017 (JP) 2017-167610

(51) Int. Cl. H01M 12/08; H01M 4/90; H01M 12/02

(52) U.S. Cl. CPC H01M 12/08; H01M 2004/8689; H01M 12/02; H01M 4/9075

(57) ABSTRACT

A lithium air battery comprises: a negative electrode configured to occlude and release a lithium ion; a positive electrode configured to use oxygen in air as a positive electrode active material; and a nonaqueous lithium ion conductor disposed between the negative electrode and the positive electrode. The positive electrode contains a copper compound as a catalyst to produce oxygen. The copper compound contains no neutral ligand and contains at least one copper ion and at least one selected from the group consisting of an iodine ion, a bromine ion, and a thiocyanate ion.

### BACKGROUND

### 1. Technical Field

The present disclosure relates to a lithium air battery that includes a nonaqueous lithium ion conductor.

### 2. Description of the Related Art

A lithium air battery is a battery in which as a positive electrode active material, oxygen in the air is used, and as a negative electrode active material, a metal or a compound capable of occluding and releasing lithium ions is used. The lithium air battery has advantages in that the energy density is high, the reduction in size can be easily achieved, and the reduction in weight can also be easily achieved. Hence, the lithium air battery has drawn attention as a battery having an energy density higher than that of a lithium ion battery which is currently considered to have the highest energy density.

In the lithium air battery, lithium peroxide is precipitated on a positive electrode by a discharge reaction and is then decomposed by a charge reaction. Lithium peroxide has low electron conductivity, which hinder the progress of the charge reaction. Hence, an improvement of cycle characteristics of the lithium air battery is disturbed.

In an air battery disclosed in Claim 1 of Japanese Unexamined Patent Application Publication (Translation of PCT Application) No. 2013-527567, in order to efficiently decompose lithium peroxide, a catalyst to produce oxygen (also called a “redox mediator” in some cases) is contained in an electrolyte liquid. The catalyst to produce oxygen promotes the decomposition of lithium peroxide by mediation of electron transfer between a positive electrode and lithium peroxide, and as a result, a charge potential is decreased.

In an air battery disclosed in Japanese Unexamined Patent Application Publication No. 2016-046039, a complex containing a noble metal is dissolved in an electrolyte liquid as a catalyst which promotes an oxygen reduction reaction.

### SUMMARY

One non-limiting and exemplary embodiment provides a technique in which in a lithium air battery, the charge potential is decreased, and at the same time, the cycle characteristics are improved.

In one general aspect, the techniques disclosed here feature a lithium air battery comprising: a negative electrode configured to occlude and release a lithium ion; a positive electrode configured to use oxygen in air as a positive electrode active material; and a nonaqueous lithium ion conductor disposed between the negative electrode and the positive electrode. The positive electrode contains a copper compound as a catalyst to produce oxygen. The copper compound contains no neutral ligand and contains at least one copper ion and at least one selected from the group consisting of an iodine ion, a bromine ion, and a thiocyanate ion.

According to an aspect of the present disclosure, the charge potential of the lithium air battery can be decreased, and at the same time, the cycle characteristics of the lithium air battery can also be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of a lithium air battery according to one embodiment of the present disclosure;

FIG. 2 is a graph showing a charge/discharge curve of a lithium air battery of each of Example 1 and Comparative Example 1;

FIG. 3 is a graph showing a charge/discharge curve of a lithium air battery of each of Example 2 and Comparative Example 1;

FIG. 4 is a graph showing a charge/discharge curve of a lithium air battery of each of Example 3 and Comparative Example 1;

FIG. 5 is a graph showing a charge/discharge curve of a lithium air battery of each of Reference Example 1 and Comparative Example 1; and

FIG. 6 is a graph showing cycle characteristics of the lithium air battery of each of Examples 1 to 3, Reference Example 1, and Comparative Example 1.

### DETAILED DESCRIPTION

### Underlying Knowledge Forming Basis of the Present Disclosure

In Japanese Unexamined Patent Application Publication (Translation of PCT Application) No. 2013-527567, the cycle characteristics of the lithium air battery has not been disclosed at all. In Japanese Unexamined Patent Application Publication No. 2016-046039, although the reaction efficiency during discharge has been disclosed, the effect during charge has not been disclosed.

In order to solve the problems in that in a lithium air battery, the progress of the charge reaction is hindered and the charge/discharge cycle characteristics are not sufficient, the present inventors carried out intensive research. As a result, a lithium air battery according to one aspect of the present disclosure was finally completed.

A lithium air battery according to a first aspect of the present disclosure comprises:
a negative electrode capable to occlude and release a lithium ion;
a positive electrode configured to use oxygen in air as a positive electrode active material; and
a nonaqueous lithium ion conductor disposed between the negative electrode and the positive electrode, wherein
the positive electrode contains a copper compound as a catalyst to produce oxygen and
the copper compound contains no neutral ligand.

According to the first aspect, since the copper compound functions as a charging catalyst which efficiently decomposes lithium peroxide, the charge potential is decreased. Accordingly, since application of a high voltage to each member of the lithium air battery can be avoided, the member thereof is suppressed from being degraded by oxidation, and the cycle characteristics of the lithium air battery are also improved. Note that the catalyst to produce oxygen is, for example, a redox mediator.

In a second aspect of the present disclosure, for example, the copper compound of the lithium air battery of the first aspect includes at least one monovalent copper ion and at least one anion ligand. When the lithium air battery is charged, a monovalent copper ion is changed into a divalent copper ion (Cu²⁺) by oxidation on the surface of the positive electrode. When the positive electrode contains an electrically conductive porous material, the monovalent copper ion is changed into a divalent copper ion (Cu²⁺) by oxidation on the surface (including the surface of the inside of each pore) of the electrically conductive porous material. The divalent copper ion functions as a charging catalyst which promotes the decomposition of lithium peroxide.

In a third aspect of the present disclosure, for example, the at least one anion ligand of the lithium air battery of the second aspect includes at least one selected from the group consisting of a halide ion, a thiocyanate ion, a sulfide ion, a sulfate ion, a trifluoromethylthiolated compound ion, an oxide ion, a hydroxide ion, an acetate ion, a carbonate ion, a cyanide ion, a perchlorate ion, a hypochlorite ion, a nitrate ion, a nitrite ion, an amide ion, a hydride ion, and a selenide ion. In the copper compound functioning as the catalyst to produce oxygen of the lithium air battery, those anion ligands are each suitable as a counter anion of a copper ion (I) without disturbing an oxidation-reduction reaction of the copper ion (I).

In a fourth aspect of the present disclosure, for example, the at least one anion ligand of the lithium air battery of the second aspect includes at least one selected from the group consisting of an iodine ion, a bromine ion, and a thiocyanate ion. According to the fourth aspect, it is believed that not only Cu⁺ shows a catalyst effect in an oxygen generation reaction, but also the iodide ion, the bromide ion, and the thiocyanate ion each function as the catalyst to produce oxygen. Besides the catalyst effect of the copper ion, the catalyst effect of each of the iodide ion, the bromide ion, and the thiocyanate ion also contributes to the improvement of the cycle characteristics.

In a fifth aspect of the present disclosure, for example, the positive electrode of the lithium air battery according to any one of the first to the fourth aspects includes a positive electrode layer and a positive electrode collector, and the positive electrode layer contains the cupper compound in an amount of not less than 1 percent by mass and not more than 50 percent by mass of a total mass of the positive electrode layer. When the content of the copper compound is appropriately controlled, the effect described above can be sufficiently obtained.

In a sixth aspect of the present disclosure, for example, the positive electrode of the lithium air battery according to any one of the first to the fourth aspects includes a positive electrode layer and a positive electrode collector, and the positive electrode layer contains the cupper compound in an amount of not less than 10 percent by mass and not more than 30 percent by mass of a total mass of the positive electrode layer. When the content of the copper compound is appropriately controlled, the effect described above can be sufficiently obtained.

In a seventh aspect of the present disclosure, for example, the positive electrode of the lithium air battery according to any one of the first to the fourth aspects includes a positive electrode layer and a positive electrode collector, and the positive electrode layer contains the cupper compound in an amount of not less than 20 percent by mass and not more than 25 percent by mass of a total mass of the positive electrode layer. When the content of the copper compound is appropriately controlled, the effect described above can be sufficiently obtained.

In an eighth aspect of the present disclosure, for example, the positive electrode of the lithium air battery according to any one of the first to the seventh aspects contains an electrically conductive porous material, and the copper compound is supported by the electrically conductive porous material described above. According to the eighth aspect, the effect of promoting the decomposition of lithium peroxide can be directly obtained at the positive electrode. For example, the electrically conductive porous material is contained in the positive electrode layer of the positive electrode of the lithium air battery according to any one of the fifth to the seventh aspects.

In a ninth aspect of the present disclosure, for example, the nonaqueous lithium ion conductor of the lithium air battery according to any one of the first to the eighth aspects contains tetraethylene glycol dimethyl ether. Since being unlikely to evaporate and being stable against oxygen radicals, tetraethylene glycol dimethyl ether is suitable as an air-battery electrolyte liquid.

Hereinafter, an embodiment of the present disclosure will be described with reference to the drawings. The present disclosure is not limited to the following embodiment.

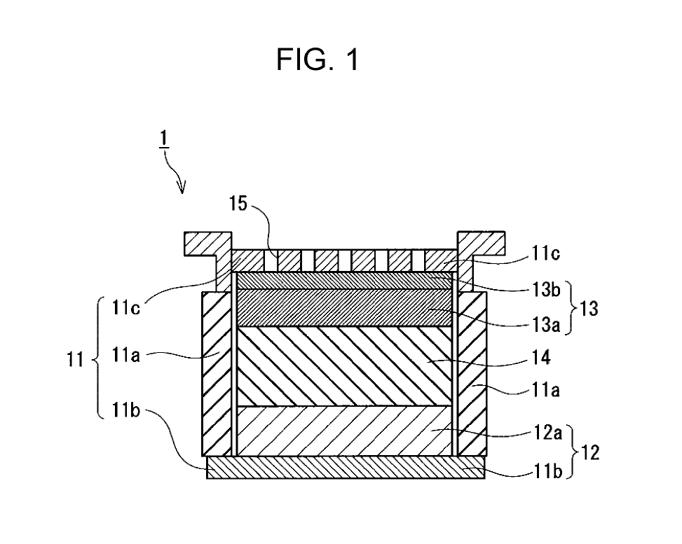

FIG. 1 is a schematic cross-sectional view of a lithium air battery according to one embodiment of the present disclosure. As shown in FIG. 1, a lithium air battery 1 of this embodiment includes a battery case 11, a negative electrode 12, a positive electrode 13, and an electrolyte layer 14 functioning as a nonaqueous lithium ion conductor. The battery case 11 includes a cylindrical portion 11 a in which a top surface side and a bottom surface side are opened, a bottom portion 11 b provided so as to close the bottom surface-side opening of the cylindrical portion 11a, and a lid portion 11c provided so as to close the top surface-side opening of the cylindrical portion 11a. In the lid portion 11c, air inlet holes 15 introducing air into the battery case 11 are provided. The negative electrode 12 includes a negative electrode layer 12a disposed on an upper surface of the bottom portion 11b of the battery case 11. The bottom portion 11b of the battery case 11 also functions as a negative electrode collector of the negative electrode 12. That is, the bottom portion 11b also functioning as the negative electrode collector and the negative electrode layer 12a collectively form the negative electrode 12. The positive electrode 13 is formed of a positive electrode layer 13a containing a carbon material and a positive electrode collector 13b disposed between the positive electrode layer 13a and the lid portion 11c of the battery case 11. The electrolyte layer 14 of the lithium air battery 1 may include a separator. Besides the bottom portion 11b, a negative electrode collector may also be provided.

A battery reaction in the lithium air battery 1 having the structure as described above is as follows.

Discharge reaction (that is, a reaction while the battery is used)

negative electrode: 2Li→2Li⁺+2e⁻(A1)

positive electrode: 2Li⁺+2e⁻+O₂→Li₂O₂(A2)

Charge reaction (that is, a reaction while the battery is charged)

negative electrode: 2Li⁺+2e⁻→2Li (A3)

positive electrode: Li₂O₂→2Li⁺+2e⁻+O₂(A4)

During the discharge, as shown by the formulas (A1) and (A2), electrons and lithium ions are released from the negative electrode 12. When electrons are incorporated into the positive electrode 13, oxygen incorporated from the outside of the battery simultaneously reacts with lithium ions at the positive electrode 13, and lithium peroxide is generated. During the charge, as shown by the formulas (A3) and (A4), electrons and lithium ions are incorporated into the negative electrode 12. From the positive electrode 13, electrons, lithium ions, and oxygen are released. The charging catalyst is a material promoting the reaction shown by the formula (A4).

Next, the individual members of the lithium air battery 1 as described above will be described in detail.

### 1. Positive Electrode

As described above, the positive electrode 13 includes the positive electrode layer 13a and may further include the positive electrode collector 13b. Hereinafter, the positive electrode layer 13a and the positive electrode collector 13b will be described respectively.

### Positive Electrode Layer

The positive electrode layer 13a contains a material which enables oxygen in the air to be oxidized and reduced as a positive electrode active material. As the material described above, the positive electrode layer 13a of this embodiment contains an electrically conductive porous material containing carbon. A carbon material to be used as the electrically conductive porous material containing carbon may have a high electron conductivity. In particular, there may be used a carbon material, such as acetylene black or Ketjen black, which is generally used as an electrically conductive auxiliary agent. In view of the specific surface area and the size of primary particles, electrically conductive carbon black, such as Ketjen black, may be used. The carbon material is generally a powder. The specific surface area of the carbon material is, for example, 800 to 2,000 m²/g and may also be 1,200 to 1,600 m²/g. When the specific surface area of the carbon material is in the range as described above, the positive electrode layer 13a is easily formed to have a fine pore structure. The specific surface area is a value to be measured by a BET method.

The positive electrode layer 13a further contains a copper compound as the catalyst to produce oxygen. The copper compound functions as the charging catalyst which efficiently decomposes lithium peroxide and decreases the charge potential. Accordingly, since application of a high voltage to each member of the lithium air battery can be avoided, the member thereof is suppressed from being degraded by oxidation, and the cycle characteristics of the lithium air battery 1 are also improved.

The copper compound may be an ionic material. In particular, the copper compound contains at least one copper ion and at least one anion ligand. The at least one copper ion contained in the copper compound is from more than zero valent to less than divalent. The at least one copper ion can be a monovalent copper ion (Cu⁺). When the lithium air battery 1 is charged, a monovalent copper ion is changed into a divalent copper ion (Cu²⁺) by oxidation on the surface of the positive electrode 13. When the positive electrode 13 contains an electrically conductive porous material, a monovalent copper ion is changed into a divalent copper ion (Cu²⁺) by oxidation on the surface (including the surface of the inside of each pore) of the electrically conductive porous material. The divalent copper ion functions as the charging catalyst which promotes the decomposition of lithium peroxide. The copper compound may be a compound formed of at least one monovalent copper ion and at least one anion ligand.

The at least one anion ligand includes at least one selected from the group consisting of a halide ion (F⁻, Cl⁻, I⁻, or Br⁻), a thiocyanate ion (SCN⁻), a sulfide ion (S²⁻), a sulfate ion (SO₄²⁻), a trifluoromethylthiolated compound ion (CF₃S⁻), an oxide ion (O²⁻), a hydroxide ion (OH⁻), an acetate ion (CH₃COO⁻), a carbonate ion (CO₃²⁻), a cyanide ion (CN⁻), a perchlorate ion (ClO₄⁻), a hypochlorite ion (ClO⁻), a nitrate ion (NO₃⁻), a nitrite ion (NO₂⁻), an amide ion (NH₂⁻), a hydride ion (H⁻), and a selenide ion (Se²⁻). In the copper compound functioning as the catalyst to produce oxygen of the lithium air battery 1, those anion ligands are each suitable as a counter anion of a copper ion (I) without disturbing the oxidation-reduction reaction of the copper ion (I). As the copper compound having at least one anion ligand, for example, there may be mentioned CuF, CuCl, CuI, CuBr, CuSCN, Cu₂S, Cu₂SO₄, CuSCF₃, Cu₂O, CuOH, CH₃COOCu, Cu₂CO₃, CuCN, CuClO₄, CuClO, CuNO₂, CuNH₂, CuH, or Cu₂Se.

Among those mentioned above, the at least one anion ligand includes at least one selected from the group consisting of an iodine ion, a bromine ion, and a thiocyanate ion. That is, the copper compound includes at least one selected from the group consisting of copper iodide (CuI), copper bromide (CuBr), and copper thiocyanate (CuSCN).

When copper iodide (CuI) is used as the copper compound, it is believed that not only Cu⁺ shows a catalyst effect in the oxygen generation reaction, but also an iodide ion (I⁻) functions as the catalyst to produce oxygen. In particular, I⁻ is changed into I₃⁻ by oxidation, and I₃⁻ functions as the catalyst to produce oxygen. Besides the catalyst effect of the copper ion, the catalyst effect of the iodide ion also contributes to the improvement of the cycle characteristics. Furthermore, the iodide ion (I⁻) forms a LiI film on the surface of the metal lithium of the negative electrode 12. By the LiI film, the surface of the negative electrode 12 is smoothed, and lithium is likely to be precipitated and dissolved. When lithium is likely to be precipitated and dissolved at the negative electrode 12, the growth of lithium dendrites which may cause short circuit is suppressed, and the cycle characteristics of the lithium air battery 1 are improved.

When copper bromide (CuBr) is used as the copper compound, it is believed that not only Cu⁺ shows a catalyst effect in the oxygen generation reaction, but also a bromide ion (Br⁻) functions as the catalyst to produce oxygen. In particular, Br⁻ is changed into Br₃⁻ by oxidation, and Br₃⁻ functions as the catalyst to produce oxygen. In addition, at a noble potential as compared to a theoretical decomposition potential of lithium carbonate (Li₂CO₃) which is a main byproduct of the discharge reaction, Br₃⁻ is further oxidized to produce Br₂. This Br₂ decomposes Li₂CO₃ by the following reaction. Accordingly, the irreversible capacity of the lithium air battery 1 is reduced, and as a result, the cycle characteristics are improved.

Li₂CO₃+3Br₂→2Br₃⁻+2Li⁺+CO₂+0.50₂

When copper thiocyanate (CuSCN) is used as the copper compound, it is believed that not only Cu⁺ shows a catalyst effect in the oxygen generation reaction, but also a thiocyanate ion (SCNr⁻) functions as the catalyst to produce oxygen. SCN⁻ is changed into (SCN)₂ by oxidation at a noble potential as compared to the theoretical decomposition potential of lithium carbonate. This (SCN)₂ also decomposes Li₂CO₃ as is the case of Br₂. Accordingly, the irreversible capacity of the lithium air battery 1 is reduced, and as a result, the cycle characteristics are improved.

In addition, when the copper compound contains a neutral ligand, the oxidation-reduction characteristics of the copper ion cannot be obtained. In this case, the copper compound is not able to function as the catalyst to produce oxygen of the lithium air battery 1. For example, tetrakis(acetonitrile)copper(I) tetrafluoroborate and copper(I) thiophenolate are each a copper compound having a neutral ligand. Tetrakis(acetonitrile)copper(I) tetrafluoroborate contains a neutral ligand, a copper ion, and an anion ligand. The neutral ligand coordinates to the copper ion, and the copper ion and the anion ligand form an ionic bond.

In this embodiment, the copper compound is contained in the positive electrode 13 (for example, in the positive electrode layer 13a). For example, particles of the copper compound are contained in the positive electrode 13. In detail, the particles of the copper compound are supported by the electrically conductive porous material forming the positive electrode 13. In other words, the copper compound in the form of particles and the electrically conductive porous material collectively form the positive electrode layer 13a. Hence, the effect of promoting the decomposition of lithium peroxide can be directly obtained at the positive electrode 13. In the positive electrode layer 13a, the copper compound is present in a solid state. Even if not dissolved in an electrolyte liquid, the copper compound is able to have the oxidation-reduction characteristics of the copper ion (I).

The content rate of the copper compound in the positive electrode layer 13a is, for example, 1 to 50 percent by mass, may be 10 to 30 percent by mass, and may also be 20 to 25 percent by mass. When the content of the copper compound is appropriately controlled, the effect described above can be sufficiently obtained. In the present disclosure, the “content rate of the copper compound in the positive electrode layer” indicates the rate ((M2/M1)×100 percent by mass) of mass M2 of the copper compound to mass M1 of the positive electrode layer.

The positive electrode layer 13a may further contain a binder fixing the copper compound to the electrically conductive porous material. As the binder, a material known as the binder for the positive electrode layer 13a of the lithium air battery 1 may be used. As the binder, for example, a poly(vinylidene fluoride) (PVdF) or a polytetrafluoroethylene (PTFE) may be mentioned. The content of the binder in the positive electrode layer 13a is not particularly limited and is, for example, in a range of 1 to 40 percent by mass.

Since being changed in accordance with the application of the lithium air battery 1, the thickness of the positive electrode layer 13a is not particularly limited. The thickness of the positive electrode layer 13a is, for example, in a range of 2 to 500 μm and may also be in a range of 5 to 300 μm.

The positive electrode layer 13a may be formed, for example, by the following method. After a solvent is added to a composition that contains powders of a carbon material and a copper compound as a charging catalyst, mixing thereof is performed. If needed, additives, such as a binder, may also be contained in the composition. The mixture (to be used as a coating liquid) thus obtained is applied on the positive electrode collector 13b by a coating method, such as a doctor blade method, and a coating film thus obtained was dried. Accordingly, the positive electrode 13 is obtained. A sheet-shaped positive electrode layer 13a without provided with the positive electrode collector 13b may be formed in such a way that after the coating film of the mixture is dried, the dried coating film is rolled by a roll press method or the like. The sheet-shaped positive electrode layer 13a may also be directly formed by compression pressing of the composition described above.

### Positive Electrode Collector

The positive electrode collector 13b is a member collecting electric charges of the positive electrode layer 13a. A material of the positive electrode collector 13b is not particularly limited as long as having an electrical conductivity. As the material of the positive electrode collector 13b, for example, stainless steel, nickel, aluminum, iron, titanium, or carbon may be mentioned. As the shape of the positive electrode collector 13b, for example, a foil shape, a plate shape, or a mesh (such as a grid) shape may be mentioned. Among those mentioned above, in this embodiment, the shape of the positive electrode collector 13b may be a mesh shape. The reason for this is that a mesh-shaped positive electrode collector 13b is excellent in electric charge collection efficiency. In this case, the mesh-shaped positive electrode collector 13b may be disposed in the positive electrode layer 13a. Furthermore, the lithium air battery of this embodiment may further include another positive electrode collector 13b (such as a foil-shaped collector) collecting electric charges collected by the mesh-shaped positive electrode collector 13b. In this embodiment, the battery case 11 which will be described later may also have a function of the positive electrode collector 13b. The thickness of the positive electrode collector 13b is, for example, in a range of 10 to 1,000 μm and may also be in a range of 20 to 400 μm.

### 2. Negative Electrode

As described above, the negative electrode 12 includes the negative electrode collector and may further include the negative electrode layer 12a. Hereinafter, the negative electrode layer 12a and the negative electrode collector will be described respectively.

### Negative Electrode Layer

The negative electrode layer 12a of this embodiment may contain a negative electrode active material capable of occluding and releasing lithium ions. As the negative electrode active material described above, a material is not particularly limited as long as containing a lithium element, and for example, there may be mentioned a simple metal (such as metal lithium), an alloy containing a lithium element, an oxide containing a lithium element, or a nitride containing a lithium element. As the alloy containing a lithium element, for example, there may be mentioned a lithium aluminum alloy, a lithium tin alloy, a lithium lead alloy, or a lithium silicon alloy. As the metal oxide containing a lithium element, for example, there may be mentioned a lithium titanium oxide. As the metal nitride containing a lithium element, for example, there may be mentioned a lithium cobalt nitride, a lithium iron nitride, or a lithium manganese nitride.

The negative electrode layer 12a may contain only the negative electrode active material or may also contain a binder besides the negative electrode active material. When the negative electrode active material has a foil shape, the negative electrode layer 12a may contain only the negative electrode active material, and when the negative electrode active material is a powder, the negative electrode layer 12a may contain both the negative electrode active material and the binder. As the binder, a material known as the binder for the negative electrode layer 12a of the lithium air battery 1 may be used, and for example, a PVdF or a PTFE may be mentioned. The content of the binder in the negative electrode layer 12a is not particularly limited and may be, for example, in a range of 1 to 40 percent by mass. As a method for forming the negative electrode layer 12a using a powdered negative electrode active material, as is the method for forming the positive electrode layer 13a described above, a formation method, such as a doctor blade method or a compression pressing method, may be used.

### Negative Electrode Collector

The negative electrode collector is a member collecting electric charges of the negative electrode layer 12a. A material of the negative electrode collector is not particularly limited as long as having an electrical conductivity. A material known as the negative electrode collector of the lithium air battery 1 may be used. As the material of the negative electrode collector, for example, copper, stainless steel, nickel, or carbon may be mentioned. As the shape of the negative electrode collector, for example, there may be mentioned a foil shape, a plate shape, or a mesh (such as a grid) shape. The negative electrode collector may be formed from a porous material having an irregular surface. The battery case 11 which will be described later may also function as the negative electrode collector.

### 3. Separator

The lithium air battery 1 of this embodiment may include a separator disposed between the positive electrode 13 (or the positive electrode layer 13a) and the negative electrode 12 (or the negative electrode layer 12a). Since the separator is disposed between the positive electrode 13 and the negative electrode 12, a highly safe battery can be obtained. As long as having a function of electrically separating the positive electrode layer 13a from the negative electrode layer 12a, the separator is not particularly limited. As the separator, for example, a porous insulating material may be used, and a porous film, such as a polyethylene (PE) porous film or a polypropylene (PP) porous film; a resin non-woven cloth, such as a PE non-woven cloth or a PP non-woven cloth; a glass fiber non-woven cloth: a paper non-woven cloth, or the like may be mentioned.

The porosity of the separator is, for example, in a range of 30% to 90%. When the porosity is in the range as described above, a sufficient amount of the electrolyte can be held in the separator, and at the same time, the separator has a sufficient strength. The porosity of the separator may also be in a range of 35% to 60%. The porosity can be calculated from the true density, the total volume including pores, and the weight of the material.

### 4. Electrolyte Layer (Lithium Ion Conductor)

The electrolyte layer 14 is a layer which is disposed between the positive electrode 13 (or the positive electrode layer 13a) and the negative electrode 12 (or the negative electrode layer 12a) and which conducts lithium ions. As long as the electrolyte layer 14 has a lithium ion conductivity (i.e., as long as the electrolyte layer 14 functions as a lithium ion conductor), the form thereof is not particularly limited and may be either a solution system represented by an organic solvent system containing a lithium salt as an electrolyte or a solid membrane system represented by a high molecular weight solid electrolyte system containing a lithium salt.

When the electrolyte layer 14 is the solution system, a nonaqueous electrolyte liquid prepared by dissolving a lithium salt in a nonaqueous solvent may be used as the electrolyte layer 14.

As the lithium slat contained as an electrolyte in the nonaqueous electrolyte liquid, for example, although lithium perchlorate (LiClO₄), lithium hexafluorophosphate (LiPF₆), lithium tetrafluoroborate (LiBF₄), lithium trifluoromethanesulfonate (LiCF₃SO₃), or lithium bistrifluoromethanesulfonylamide (LiN(CF₃SO₂)₂) may be mentioned, the lithium salt is not limited thereto. As the electrolyte of the nonaqueous electrolyte liquid of the lithium air battery 1, a known lithium salt may be used.

The concentration of the electrolyte in the nonaqueous electrolyte liquid is, for example, 0.5 to 2.5 mol/L. When a solution system electrolyte layer 14 (such as a nonaqueous electrolyte liquid) is used, this nonaqueous electrolyte liquid is held by immersion thereof in the separator as described above, so that the electrolyte layer 14 can be formed.

As the nonaqueous solvent, nonaqueous solvents known as the nonaqueous solvents of the nonaqueous electrolyte liquid of the lithium air battery 1 may be used. Among the above nonaqueous solvents, in particular, a chain ether, such as tetraethylene glycol dimethyl ether or tetraethylene glycol diethyl ether, may be used as the solvent. Compared to a carbonate-based solvent, the chain ether is not likely to cause a side reaction other than the oxidation-reduction reaction of oxygen in the positive electrode 13. In particular, since being unlikely to evaporate and being stable against oxygen radicals, tetraethylene glycol dimethyl ether is preferable as an air-battery electrolyte liquid.

In addition, the nonaqueous solvent of the nonaqueous electrolyte liquid may be a nonaqueous solvent into which the copper compound is difficult to be dissolved. For example, the copper compound, such as CuI, is extremely difficult to be dissolved into the chain ether represented by tetraethylene glycol dimethyl ether. In this case, the catalyst function of the copper compound can be reliably and continuously obtained at the positive electrode layer 13a. The term of “difficult to be dissolved” indicates that, for example, the solubility of the copper compound to the nonaqueous solvent is 20 μmol/liter or less at 25° C.

### 5. Battery Case

As long as capable of receiving the positive electrode 13, the negative electrode 12, and the electrolyte layer 14 as described above, the battery case 11 of the lithium air battery 1 of this embodiment may have any shape. The shape of the battery case 11 of the lithium air battery 1 of this embodiment is not limited to the shape shown in FIG. 1, and various battery cases, such as a coin type, a flat plate type, a cylindrical type, and a laminate type may be used. The battery case 11 may be either an air-open type battery case or an airtight type battery case. The air-open type battery case has an airflow hole through which the air is charged and discharged and is a case in which the air is contactable with the positive electrode. When the airtight type battery case is used, a supply pipe and an exhaust pipe of a gas (such as air) may be provided for the airtight type battery case. In this case, the gas to be supplied and exhausted may be dry air. The gas to be supplied and exhausted may have a high oxygen concentration or may be pure oxygen (e.g., oxygen concentration: 99.99%). The oxygen concentration may be high during discharge and may be low during charge.

### EXAMPLES

Hereinafter, the present disclosure will be described in more detail with reference to examples. In addition, the following examples will be described by way of example, and the present disclosure is not limited to the following examples.

### Example 1

As a carbon material, a powder of Ketjen black (manufactured by Lion Corporation) was used. As a binder, a powder of a PTFE (manufactured by Daikin Industries, Ltd.) was used. The carbon material, powdered copper iodide (CuI), and the binder were kneaded together at a mass ratio of 40:15:10 using an ethanol solvent, so that a mixture was obtained. The mixture was rolled by a roll press method, so that an electrode sheet was formed. The electrode sheet thus obtained was cut, so that a positive electrode (positive electrode layer) was obtained.

Lithium bistrifluoromethanesulfonylamide (LiTFSA, manufactured by Kishida Chemical Co., Ltd.) was mixed with and dissolved in tetraethylene glycol dimethyl ether (TEGDME, manufactured by Kishida Chemical Co., Ltd.) so as to have a concentration of 1 mol/L. The mixed solution was stirred for 24 hours in a dry air atmosphere having a dew point of −50° C. or less, so that a nonaqueous electrolyte liquid was obtained.

Next, as a separator, a glass fiber separator was prepared. A SUS304 mesh (manufactured by The Nilaco Corporation) was adhered to metal lithium foil (manufactured by The Honjo Chemical Corporation), so that a negative electrode was obtained. By the use of the positive electrode, the separator, the nonaqueous electrolyte liquid, and the negative electrode, a lithium air battery having the structure shown in FIG. 1 was formed.

### Example 2

Except for that a CuBr powder was used instead of using the CuI powder, by the same method as that of Example 1, a lithium air battery was formed.

### Example 3

Except for that a CuSCN powder was used instead of using the CuI powder, by the same method as that of Example 1, a lithium air battery was formed.

### Reference Example 1

Except for that a tetrakis(acetonitrile)copper(I) tetrafluoroborate powder was used instead of using the CuI powder, by the same method as that of Example 1, a lithium air battery was formed.

### Comparative Example 1

Except for that CuI was not used, by the same method as that of Example 1, a lithium air battery of Comparative Example 1 was formed.

### Charge/Discharge Test

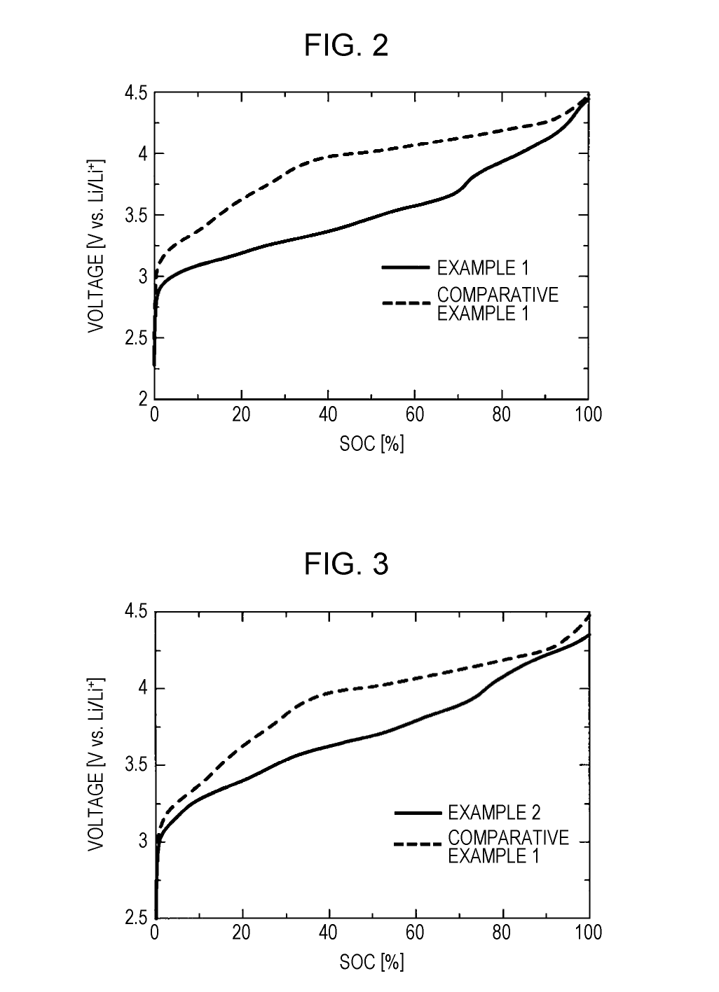

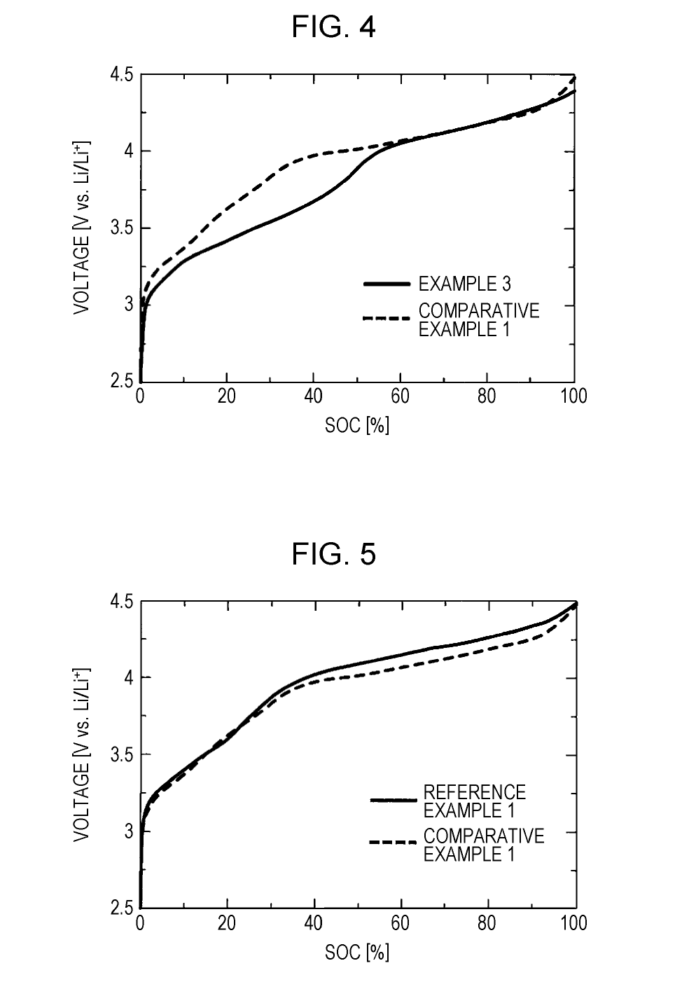

After the lithium air battery of each of Examples 1 to 3, Reference Example 1, and Comparative Example 1 was held in an oxygen atmosphere for 20 minutes or more, a charge/discharge test was performed. The current density during discharge was 0.4 mA/cm², and the cutoff voltage was 2.0 V. The current density during charge was 0.1 mA/cm², and the cutoff voltage was 4.5 V. After the discharge was performed, the charge was performed. The charge curves thus obtained are shown in FIGS. 2 to 5. FIG. 2 is a graph showing a charge/discharge curve of the lithium air battery of each of Example 1 and Comparative Example 1. FIG. 3 is a graph showing a charge/discharge curve of the lithium air battery of each of Example 2 and Comparative Example 1. FIG. 4 is a graph showing a charge/discharge curve of the lithium air battery of each of Example 3 and Comparative Example 1. FIG. 5 is a graph showing a charge/discharge curve of the lithium air battery of each of Reference Example 1 and Comparative Example 1. SOC (State Of Charge) along the horizontal axis of each of FIGS. 2 to 5 represents the charging rate, and Voltage along the vertical axis represents a battery voltage with reference to the oxidation-reduction potential of the negative electrode lithium.

As shown in FIGS. 2 to 4, the charge potential of the lithium air battery of each of Examples 1 to 3 was lower than the charge potential of the lithium air battery of Comparative Example 1. In Examples 1 to 3, it is estimated that Cu⁺ supplied from the copper compound was changed into Cu²⁺ by oxidation on the surface of the positive electrode, and this Cu²⁺ functioned as the charging catalyst which efficiently decomposed lithium peroxide, so that the charge potential was decreased. According to the technique of the present disclosure, since application of a high voltage to each member of the lithium air battery can be avoided, the member thereof can be suppressed from being degraded by oxidation.

As shown in FIG. 5, the charge potential of Reference Example 1 was approximately the same as the charge potential of Comparative Example 1. In Reference Example 1, it is estimated that since the ligands bonded to copper ions are neutral, the oxidation-reduction characteristics thereof cannot be obtained, and as a result, the effect of the catalyst to produce oxygen of the lithium air battery cannot be obtained.

### Charge/Discharge Cycle Test

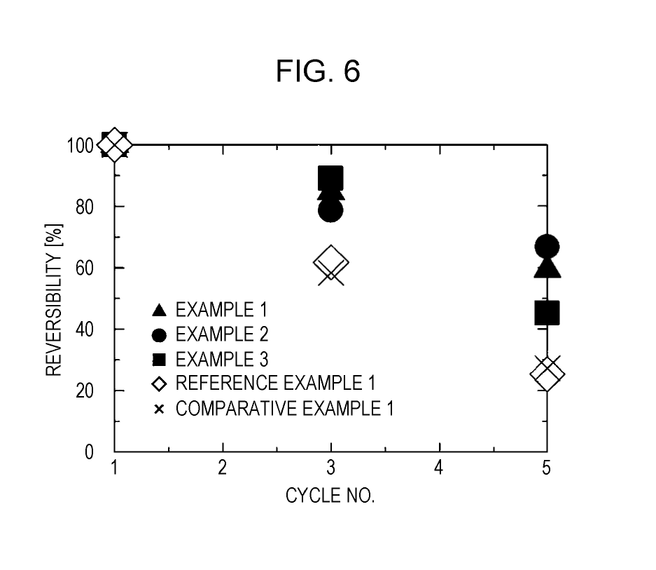

Under the same conditions as those described in the charge/discharge test, a charge/discharge cycle test of the lithium air battery of each of Examples 1 to 3, Reference Example 1, and Comparative Example 1 was performed. In particular, the charge and the discharge are each repeatedly performed five times. The results are shown in FIG. 6. FIG. 6 is a graph showing the cycle characteristics of the lithium air battery of each of Examples 1 to 3, Reference Example 1, and Comparative Example 1. In FIG. 6, the horizontal axis represents the number of charge/discharge cycles. The vertical axis represents the rate of the discharge capacity of each cycle to the discharge capacity of the first cycle.

As shown in FIG. 6, compared to the capacity of the lithium air battery of Comparative Example 1, the capacity of the lithium air battery of Example 1 was not likely to be decreased. In the lithium air battery of Example 1, it is estimated that Cu⁺ functioned as the charging catalyst which efficiently decomposed lithium peroxide. In addition, it is estimated that iodide ions also functioned as the catalyst to produce oxygen. In particular, I⁻ is changed into I₃⁻ by oxidation, and I₃⁻ functions as the catalyst to produce oxygen. Furthermore, it is estimated that the iodide ions (I⁻) formed a LiI film on the surface of the metal lithium of the negative electrode, and by this LiI film, the capacity was suppressed from being decreased. In particular, the surface of the negative electrode is smoothed by the LiI film, and precipitation and dissolution of lithium are likely to occur. When the precipitation and the dissolution of lithium are likely to occur at the negative electrode, the growth of lithium dendrites which may cause short circuit is suppressed, and as a result, the cycle characteristics of the lithium air battery are improved.

Compared to the capacity of the lithium air battery of Comparative Example 1, the capacity of the lithium air battery of Example 2 was also not likely to be decreased. In the lithium air battery of Example 2, it is estimated that Cu⁺ not only functioned as the charging catalyst which efficiently decomposed lithium peroxide, but bromide ions also functioned as the catalyst to produce oxygen. In particular, Br⁻ is changed into Br₃⁻ by oxidation, and Br₃⁻ functions as the catalyst to produce oxygen. In addition, at a noble potential as compared to the theoretical decomposition potential of lithium carbonate (Li₂CO₃) which is a main byproduct of the discharge reaction, Br₃⁻ is further oxidized, and as a result, Br₂ is generated. This Br₂ decomposes Li₂CO₃ by the following reaction. Accordingly, the irreversible capacity of the lithium air battery is reduced, and the cycle characteristics are improved.

Li₂CO₃+3Br₂→2Br₃⁻+2Li⁺+CO₂+0.50₂

Compared to the capacity of the lithium air battery of Comparative Example 1, the capacity of the lithium air battery of Example 3 was also not likely to be decreased. In the lithium air battery of Example 3, it is estimated that Cu⁺ not only functioned as the charging catalyst which efficiently decomposed lithium peroxide, but thiocyanate ions also functioned as the catalyst to produce oxygen. SCN⁻ is changed into (SCN)₂ by oxidation at a noble potential as compared to the theoretic decomposition potential of lithium carbonate. This (SCN)₂ also decomposes Li₂CO₃ as is the case of Br₂. Accordingly, the irreversible capacity of the lithium air battery is reduced, and the cycle characteristics are improved.

The capacity of the lithium air battery of Reference Example 1 was decreased as is the case of the capacity of the lithium air battery of Comparative Example 1. The reason for this is that since the ligands bonded to copper ions are neutral, the oxidation-reduction characteristics of the copper ions cannot be obtained, and as a result, the effect as the catalyst to produce oxygen of the lithium air battery cannot be obtained.

The lithium air battery of the present disclosure has, for example, a high capacity and preferable charge/discharge cycle characteristics. Hence, the lithium air battery of the present disclosure is useful, for example, as a secondary battery.

What is claimed is:

1. A lithium air battery comprising:
a negative electrode configured to occlude and release a lithium ion;
a positive electrode configured to use oxygen in air as a positive electrode active material; and
a nonaqueous lithium ion conductor disposed between the negative electrode and the positive electrode, wherein the positive electrode contains a copper compound as a catalyst to produce oxygen, and
the copper compound contains no neutral ligand and contains at least one copper ion and at least one selected from the group consisting of an iodine ion, a bromine ion, and a thiocyanate ion.

2. The lithium air battery according to claim 1,
wherein the copper compound further contains at least one selected from the group consisting of a halide ion, a thiocyanate ion, a sulfide ion, a sulfate ion, a trifluoromethylthiolated compound ion, an oxide ion, a hydroxide ion, an acetate ion, a carbonate ion, a cyanide ion, a perchlorate ion, a hypochlorite ion, a nitrate ion, a nitrite ion, an amide ion, a hydride ion, and a selenide ion.

3. The lithium air battery according to claim 1,
wherein the positive electrode includes a positive electrode layer and a positive electrode collector, and
the positive electrode layer contains the cupper compound in an amount of not less than 1 percent by mass and not more than 50 percent by mass of a total mass of the positive electrode layer.

4. The lithium air battery according to claim 1,
wherein the positive electrode includes a positive electrode layer and a positive electrode collector, and
the positive electrode layer contains the cupper compound in an amount of not less than 10 percent by mass and not more than 30 percent by mass of a total mass of the positive electrode layer.

5. The lithium air battery according to claim 1,
wherein the positive electrode includes a positive electrode layer and a positive electrode collector, and
the positive electrode layer contains the cupper compound in an amount of not less than 20 percent by mass and not more than 25 percent by mass of a total mass of the positive electrode layer.

6. The lithium air battery according to claim 1,
wherein the positive electrode further contains an electrically conductive porous material and
the copper compound is supported by the electrically conductive porous material.

7. The lithium air battery according to claim 2,
wherein the positive electrode further contains an electrically conductive porous material and
the copper compound is supported by the electrically conductive porous material.

8. The lithium air battery according to claim 3,
wherein the positive electrode layer further contains an electrically conductive porous material and
the copper compound is supported by the electrically conductive porous material.

9. The lithium air battery according to claim 4,
wherein the positive electrode layer further contains an electrically conductive porous material and
the copper compound is supported by the electrically conductive porous material.

10. The lithium air battery according to claim 5,
wherein the positive electrode layer further contains an electrically conductive porous material and
the copper compound is supported by the electrically conductive porous material.

11. The lithium air battery according to claim 1,
wherein the nonaqueous lithium ion conductor contains tetraethylene glycol dimethyl ether.
